(19) United States
(12) Patent Application Publication
(10) Pub. No.: US 2010/0180380 A1
(43) Pub. Date: Jul. 22, 2010

(54) DRIVE SYSTEM FOR PATIENT SUPPORT

(75) Inventors: Mattheas Robertus VAN SCHEPPINGEN, TB HULSHORST (NL); Joost Anton Roes, TK DIDAM (NL)

Correspondence Address: LADAS & PARRY LLP, 26 WEST 61ST STREET, NEW YORK, NY, 10023, US

(73) Assignee: EXODUS HOLDING B.V.

(21) Appl. No.: 12/690,436

(22) Filed: Jan. 20, 2010

(30) Foreign Application Priority Data
Jan. 20, 2009 (NL) 2002433
May 18, 2009 (NL) 2002903

(51) Int. Cl. B62D 51/04; B62B 3/00; A47C 21/00; A61G 7/05; A61G 7/14; A61G 7/10

(52) U.S. Cl. 5/510; 180/19.1; 180/12; 180/19.2

(57) ABSTRACT

The invention relates to a drive system for driving movement of a patient support device across a floor, comprising a base having a front side facing the patient support device, first and second drive wheels arranged on said base said wheels being rotatable around first and second respective wheel axles substantially parallel to the floor and rotatable around first and second respective swivel axles substantially perpendicular to the floor, wherein the first and second swivel axles are spaced apart from each other when projected onto the front side and arranged at fixed positions on the base, wherein the drive wheels are rotatable around their swivel axles between a first orientation for forward movement, and a second orientation for transverse movement, wherein in the second orientation the first and second drive wheels are positioned at substantially different distances from the front side of the base.

### BACKGROUND

The invention relates to a drive system for driving movement of a patient support device across a floor. Hospitalized patients or incapacitated persons are often moved about relatively long distances while lying on a bed or shorter distances using a for instance a patient lift device. These patient supports are often heavy and difficult to maneuver, especially when space is scarce. To reduce the physical effort required to move these patient supports, prior art inventions provide externally powered drive systems that may be attached to a patient support.

European patent EP 0 680 433 discloses a transport apparatus for powered transport of a hospital bed, the transport apparatus being adapted to be docked to the head end of the bed, wherein the transport apparatus comprises a base with casters thereon, and handles connected to and extending so upwardly from the transport apparatus base for grasping the apparatus and maneuvering the apparatus and the hospital bed, wherein the apparatus further comprises a drive wheel rotatably mounted on the transport apparatus base, a motor for propelling the drive wheel, a joystick type potentiometer for controlling the drive wheel, and gassprings operable between the transport apparatus and the bed for exerting a downward force on the drive wheel to reduce a tendency of the drive wheel to slip on a floor surface.

The prior art apparatus is suitable for pushing or pulling a patient support in a forward or backward direction in line with its centre of mass. However when the patient support needs to be moved in an other direction, for example at an angle with respect to the direction of a connecting line between the driving wheel and the centre of mass, the drive system and bed will have a tendency to rotate around the centre of mass of the patient support and the drive system combined. This tendency to rotate around said centre of mass greatly hinders direct lateral movement of the patient support, and may require a substantial physical effort in order to keep the patient support in track.

It is an object of the present invention to provide a drive system for a patient support which at least partially solves these problems.

### SUMMARY OF THE INVENTION

To this end, according to a first aspect the present invention provides a drive system for driving movement of a patient support device across a floor, comprising a base having a front side facing the patient support device, first and second drive wheels arranged on said base for supporting the base on the floor, said wheels being rotatable around first and second respective wheel axles substantially parallel to the floor and rotatable around first and second respective swivel axles substantially perpendicular to the floor, wherein the first and second swivel axles are spaced apart from each other when projected onto the front side and arranged at fixed positions on the base, drive actuator means for rotating the first and second drive wheels around their respective wheel axles, swivel actuator means for rotating the first and second drive wheels around their respective swivel axles, a power supply for supplying the drive actuator means and/or swivel actuator means with power, control means for controlling the drive actuator means and swivel actuator means, coupling means for substantially rotation-fixedly coupling the first and second swivel axles, wherein the drive wheels are rotatable around their swivel axles between a first orientation in which both wheel axles extend substantially parallel to the front side, and a second orientation in which both wheel axles extend substantially perpendicular to the front side, wherein in the second orientation the first and second drive wheels are positioned at substantially different distances from the front side of the base.

When moving the drive system according to the invention in an intended direction substantially toward the front of the base, the drive wheels follow different, substantially spaced apart, tracks across the floor. But also when moving the drive system according to the invention in an intended substantially transverse direction, the drive wheels follow different, substantially spaced apart tracks across the floor. At least in both these situations, the different tracks are spaced apart, which greatly reduces the tendency of a drive system and patient support to rotate around a shared centre of mass. This results in improved maneuverability.

Additionally, as the locations of the swivel axles are fixed with respect to the base, the area of support spanned by the drive system and the patient support may be constant and known beforehand; users of a drive system according to this embodiment do not have to worry about such an area of support becoming too small when steering the device.

In an embodiment the patient support device has a centre of mass (L) located substantially in a vertical plane (C) with respect to the base, the drive wheels being rotatable around their swivel axles between a first orientation in which both wheel axles extend substantially parallel to the vertical plane, and a second orientation in which both wheel axles extend substantially perpendicular to the vertical plane, and wherein in the second orientation the first and second drive wheels are arranged at substantially different distances from the centre of mass (R1, R2) instead of or in addition to being positioned at substantially different distances from the front side of the base. Again, when the drive wheels are propelled to move the patient support, the tracks of the wheels, at least in a direction substantially towards the centre of mass or a direction transverse thereto are spaced apart, greatly reducing the tendency of a drive system and patient support to rotate around a shared centre of mass. This results in improved maneuverability.

In an embodiment a centre line through the locations of the swivel axles of the drive wheels on the base is both substantially non-parallel and non-perpendicular to front side of the base or the vertical plane of the centre of mass.

In an embodiment the first and second swivel axles are spaced apart when projected onto a plane perpendicular to the front side of the base. Thus a line connecting the first and second swivel axle is placed at an angle, preferably an angle larger than 0 degrees but smaller than 90 degrees, with respect to a direction toward the front of the base.

In an embodiment the rotation around the swivel axles of the first and second drive wheels is rotation-fixedly coupled for holding the respective wheel axles in a substantially parallel orientation. Both drive wheels may thus propel the drive system and patient support in the same direction, along substantially parallel spaced apart tracks, which may further reduce the tendency of a drive system and patient support to rotate around a shared centre of mass.

In an embodiment the drive actuator means are comprised in the respective first and second drive wheels, allowing quick and easy replacement of either one of the drive wheels and corresponding part of the drive actuator means, as well as a relatively simple construction. Moreover, by having the drive actuator means comprised inside the drive wheels, as is the case when motor-in-wheel type drive wheels are used, space is saved on the base and the mass of the drive actuator means is placed close to the floor.

In an embodiment the drive actuator means comprises separate actuator means for each drive wheel, facilitating replacement and repair thereof.

In an embodiment the rotational coupling of the drive wheels around their respective swivel axles comprises a mechanical coupling, preferably a belt, providing a simple and reliable rotation-fixed coupling. In an embodiment the swivel actuator means comprises an motor, preferably an electromotor, arranged on the base for driving the mechanical coupling of the drive wheels around their swivel axles. A single motor may thus be used to rotate both drive wheels around their swivel axles, saving weight and simplifying construction of the drive system.

In an embodiment the control means are adapted to control the swivel actuator means to rotate the first and second drive wheels around their respective swivel axles at substantially equal speeds. In an embodiment the swivel actuator means comprises a first and a second servomotor for rotating the first and second drive wheels around their swivel axles respectively. The control means may thus control the swivel actuator means to keep the wheel axles of both drive wheels parallel, that is to rotate the first and second drive wheels around their swivel axles over substantially equal angles of rotation. In addition or alternatively the control means may also be arranged to vary the angle between the wheel axles of the drive wheels. The latter case may be useful when small turning circles of the drive system are desired.

In an embodiment the patient support device comprises a patient lifting device or a hospital bed. In an embodiment the drive system is an integral part of the patient support device.

In an embodiment the drive system further comprises attachment means for releasably attaching the drive system to the patient support device. A simple snap or clamp connection may suffice for hospital beds, whereas more heavy duty custom made attachment means are more suitable for patient lift devices.

In an embodiment the drive system is adapted for releasably attaching to a hospital bed at any position on a side of the bed. Thus even when it is not possible to place the drive system at optimal positions near the longitudinal or lateral axes it is still possible to use the drive system with improved maneuverability to move a bed.

In an embodiment the control means control the drive actuator means to move the running surfaces of the first and second wheels with respect to the floor at substantially equal speeds. As the drive wheels are arranged to follow different tracks the drive system may move in a direction substantially parallel to the running surfaces of the drive wheels.

In an embodiment the control means are adapted to control the drive actuator means to move the first and second wheels around their respective wheel axles at substantially equal speeds.

In an embodiment the control means are adapted to control the drive actuator means to move the running surfaces of the first and second wheels with respect to the floor in opposite directions. When the drive wheels are oriented substantially away from a centre line through both wheels this will cause the drive system to rotate around a point between the drive wheels.

In an embodiment the drive system further comprises a steering handle adapted for generating a signal representing one or more force components manually applied to the handle, wherein the control means are adapted for controlling the drive and/or swivel actuator means based on said signal. Examples of suitable steering handles are a joystick or a push-handle.

In an embodiment the steering handle is a push handle adapted for applying force on the push hande to steer movement of the base. The manually applied force may also provide additional driving force to the force supplied by the actuator means. In case of loss of power or malfunction of the actuator means the drive device can still be used to transfer people.

In a embodiment the control means are adapted for controlling the driving and swivel actuator for propelling the drive system in the same direction as the push handle is pushed.

In an embodiment the attachment means comprise an adapter plate arranged on the base, for connecting the drive system to different patient support devices. This embodiment is suitable for driving movement of several kinds of patient support devices, such as lift devices, stand-up lifts, bathing lifts and the like. European patent 1.595.519 discloses different lift devices which can be arranged on the base of the invention.

According to a further aspect, the invention provides a drive system for driving movement of a patient support device across a floor, comprising a base having a front side facing a forward movement direction, a first drive wheel arranged on said base for supporting the base on the floor, wherein said first drive wheel is drivable to rotate around a first wheel axis substantially parallel to the floor along a first track, and wherein the first drive wheel is rotatable with respect to said base around a first swivel axle substantially perpendicular to the floor,

a second drive wheel arranged spaced apart from said first drive wheel on said base for supporting the base on the floor, wherein said second drive wheel is drivable to rotate around a second wheel axis substantially parallel to the floor along a second track, and wherein the second drive wheel is rotatable with respect to said base around a second swivel axle substantially perpendicular to the floor, wherein the first swivel axle is spaced apart from the second swivel axle, and

wherein the first and second drive wheels are rotatable around their swivel axles between a first orientation in which both wheel axes extend substantially perpendicular to the forward movement direction, and a second orientation in which both wheel axes extend substantially parallel to the forward movement direction, wherein in the second orientation the first track is spaced apart from the second track.

In a first embodiment the first track is substantially parallel to the second track.

According to a further aspect, the invention provides a drive system for driving movement of a patient support device across a floor, comprising a base having a front side facing a forward movement direction, a first drive wheel arranged on said base for supporting the base on the floor, wherein said first drive wheel is drivable to rotate around a first wheel axis substantially parallel to the floor, and wherein the first drive wheel is rotatable with respect to said base around a first swivel axle substantially perpendicular to the floor,

a second drive wheel arranged spaced apart from said first drive wheel on said base for supporting the base on the floor, wherein said second drive wheel is drivable to rotate around a second wheel axis substantially parallel to the floor, and wherein the second drive wheel is rotatable with respect to said base around a second swivel axle substantially perpendicular to the floor, wherein the first swivel axle is spaced apart from the second swivel axle, and

wherein the first and second drive wheels are rotatable around their swivel axles between a first orientation in which both wheel axes extend substantially perpendicular to the forward movement direction, and a second orientation in which both wheel axes extend substantially parallel to the forward movement direction, wherein in the second orientation the first wheel axis is spaced apart from the second wheel axis.

In a first embodiment the first wheel axis (h1) is spaced apart from the second wheel axis (h2) in the first orientation. In an alternative second embodiment the first wheel axis (h1) and the second wheel axis (h2) substantially coincide in the first orientation.

According to a further aspect the invention provides a patient support device comprising a drive system as described above.

The various aspects and features described and shown in the specification can be applied, individually, wherever possible. These individual aspects, in particular the aspects and features described in the attached dependent claims, can be made subject of divisional patent applications.

### BRIEF DESCRIPTION OF THE DRAWINGS

The invention will be elucidated on the basis of an exemplary embodiment shown in the attached drawings, in which:

FIG. 1 shows a perspective view of a drive system according to the invention to which a patient lift device is attached,

FIG. 2A shows a bottom view of the drive system of FIG. 1 with the drive wheels in the first position,

FIG. 2B shows a bottom view of the drive system of FIG. 1 with the drive wheels in the first position,

FIGS. 3A and 3B show a detailed perspective view and a corresponding side view respectively of the drive system,

FIG. 4 shows a top view of a drive system according to the invention attached to a hospital bed.

FIGS. 5A and 5B show a top view and a corresponding side view respectively of an alternative embodiment of the invention, in which the drive wheels are in a first orientation,

FIG. 6 shows a top view of the same drive system of FIGS. 5A and 5B, in which the drive wheels are in an intermediate orientation,

FIGS. 7A and 7B show a top view and a corresponding side view respectively in which the drive wheels are in a second orientation.

### DETAILED DESCRIPTION OF THE INVENTION

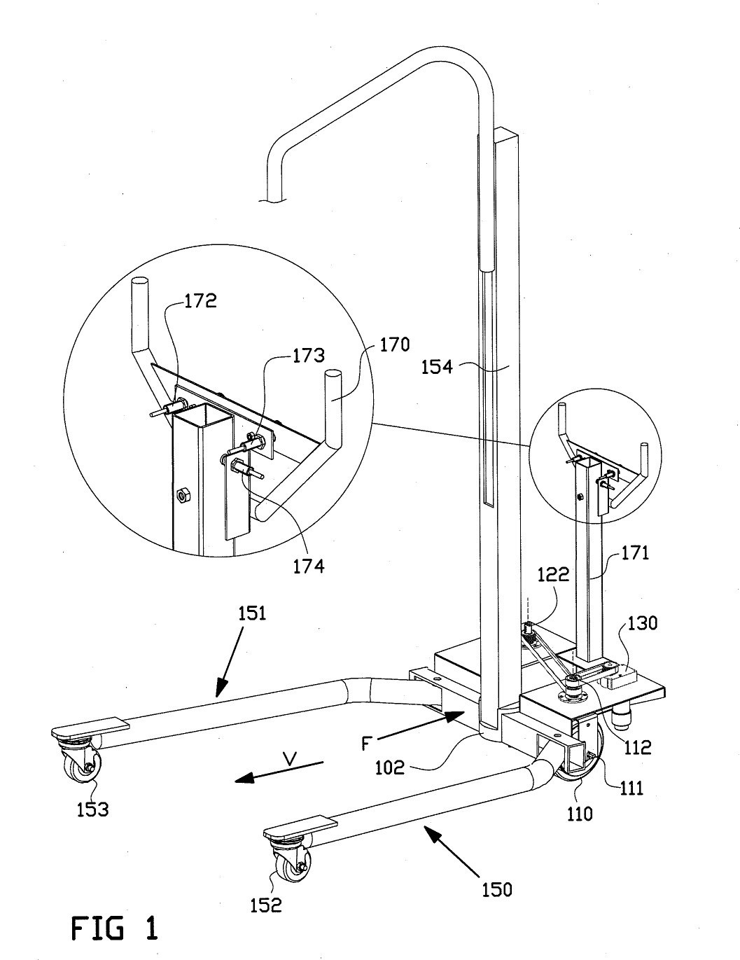

FIG. 1 shows a perspective view of a first exemplary embodiment of a drive system 100 according to the invention. The front side F of the drive system 100 coupled to a patient lift device 150 by means of attachment means 102. The patient lift device comprises two support legs 150, 151 with castor wheels 152, 153 and further comprises a lifting boom 154 for lifting a person. The drive system further comprises swivel actuator means 130, in this case an electromotor, for driving rotation of the drive wheels about their swivel axles 112, 122. Steering handle 170 is mounted on support column 171 which in turn is mounted on the base 101. The steering handle 170 is capable of generating a signal representing one or more force components manually applied thereto. These signals may be used by the control means located inside the steering handle to cause the entire drive system to move in an intuitive manner, that is the drive system is driven in a direction substantially parallel to a direction of a force applied to the handle 170.

In order to provide the required signals, several sensors are arranged between the handle 170 and the support column 171, in particular force sensors 172, 173, 174. Two sensors 172, 173 are arranged for sensing forces in a forward direction, that is in the direction towards the front F of the device. However, since the drive system of the invention is also particularly suitable for driving sideways, an additional sensor 174 is arranged for sensing sideway forces applied to the handle 170.

The lift device and the drive system together form a support area within which a load such as a person may be supported. It this respect it is important that the swivel axles 112, 122 are spaced apart when projected onto the front F of the drive system; if they were to coincide, the drive system and patient support would be unstable and likely to topple.

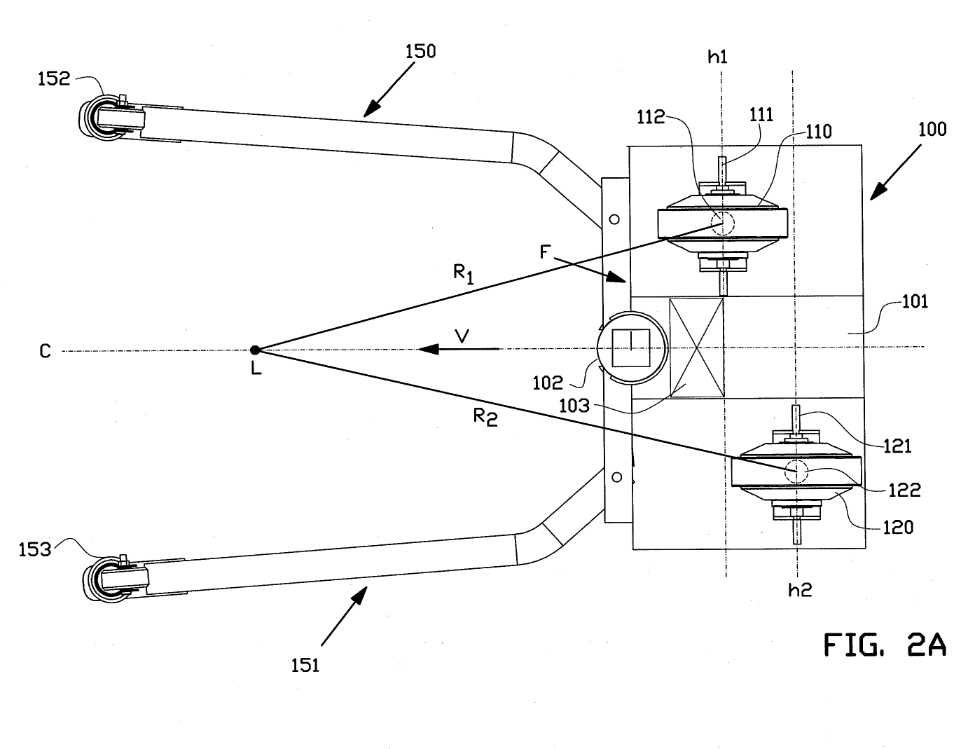

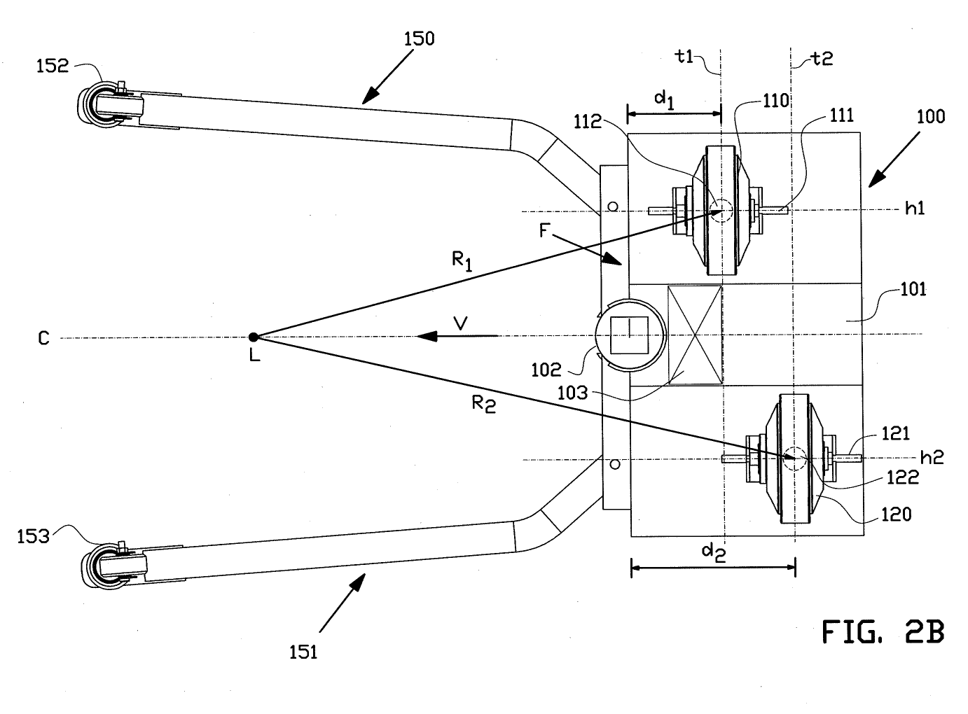

In FIGS. 2A and 2B a bottom view of a drive system 100 of FIG. 1 is shown.

The drive system comprises a base 101, a first drive wheel 110 and a second drive wheel 120. A patient lift device may be attached to the base 101 using the attachment means 102, which are located between the front F of the base and the power supply 103.

The drive wheels 110, 120 may rotate around their respective wheel axles 111,121 to move the drive system across a floor and may rotate around their respective swivel axles 112,122 to change the direction in which the drive system may be moved. The first drive wheel 110 and second drive wheel 120 together with the support legs 150,151 span a support area for supporting a patient to be moved. The combination of the drive system and the patient support has a centre of mass L located in front of the front F, preferably substantially in a plane of symmetry C of the patient support device.

As is clearly shown in FIG. 2A, the distance between the position of the first swivel axle 112 and the front F is different from the distance between the position of the second swivel axle 122 and the front F. Also the distance R1 between the position of the first swivel axle 112 and the centre of mass L is different from the distance R2 between the position of the second swivel axle 122 and the centre of mass L.

In the situation of FIG. 2A, the drive system 100 is configured for driving the patient support substantially in the forward moving direction v. In this first orientation or position a centre line or axis h1 of the first drive wheel 110 is parallel and spaced apart from a centre line or axis h2 of the second drive wheel 120.

In the situation of FIG. 2B, the drive system 100 is configured for driving the patient support in a transverse direction substantially perpendicular to the forward moving direction v, i.e. parallel to the front side F of the base 101. In this second orientation or position the first drive wheel 110 is positioned at a distance d1 from the front side F of the base, and second drive wheel 120 is positioned at a substantially different distance d2 from the front side F of the base. In this second position, the centre line or axis h1 of the first drive wheel 110 is also parallel and spaced apart from a centre line or axis h2 of the second drive wheel 120. When the drive wheels 110,120 are actuated to rotate around their wheel axles 111,121, the drive wheels both follow a track t1, t2 substantially perpendicular to the plane of symmetry C, yielding two substantially parallel tracks t1, t2 at different distances d1, d2 to the front side F of the base, providing sideways movement of the drive system without substantial deviation towards the centre of mass of the load. In addition the two substantially parallel tracks are also at different distances R1, R2 to the centre of mass L of the load.

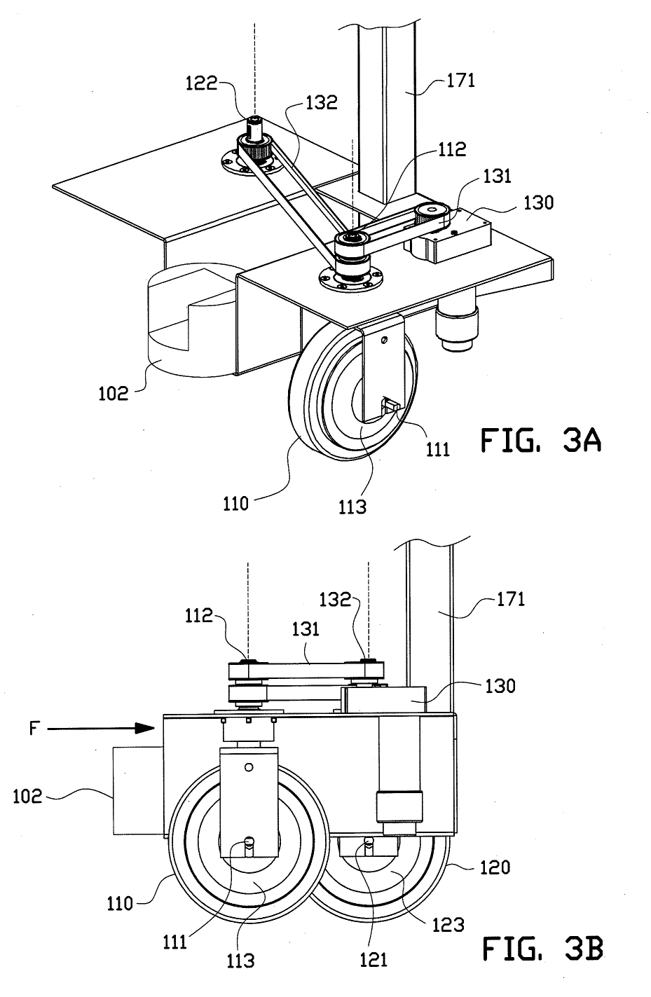

FIG. 3A shows a detail of part of the drive system of FIG. 2. The swivel actuator means 130 is clearly visible, as are the mechanical couplings, belts 131,132 that transfer movement of the electromotor 130 to the swivel axles 112,122 of the wheels. Each drive wheel 110, 120 comprises a drive actuator means 113, 123. In the embodiment shown two motors-in-wheel are used as drive actuator means for the first and second drive wheels respectively.

FIG. 3B shows a side view of FIG. 3A showing the drive actuator means 123 of the second drive wheel 120 as well.

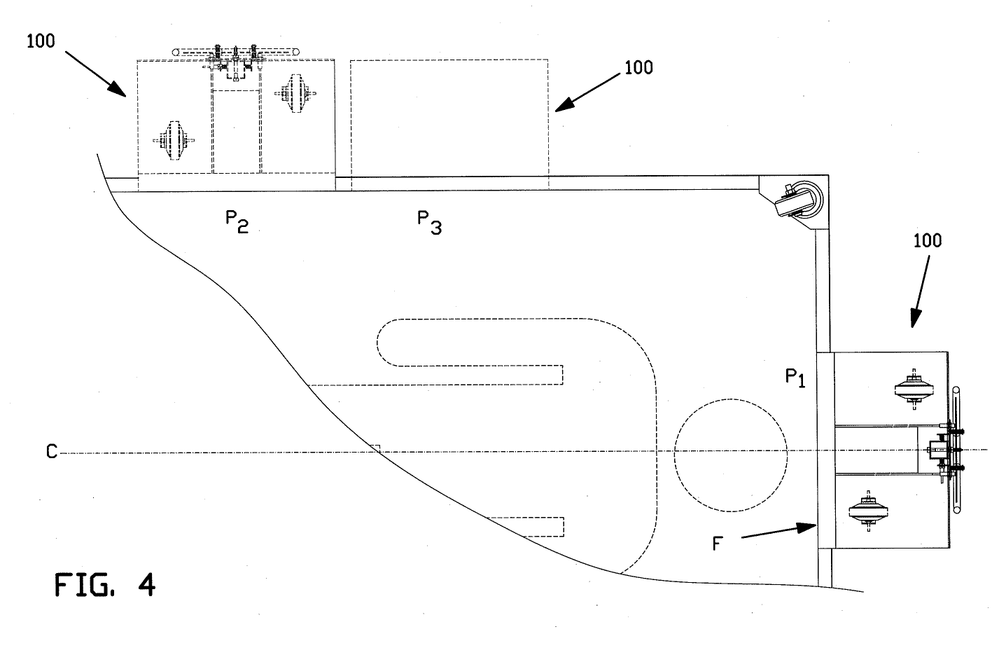

In FIG. 4 a bottom view of the drive system 100 is shown, attached to a hospital bed 160. The drive system may be attached to the hospital bed 160 at different positions, for instance at positions P1, P2, P3. When attached at position P1 the drive system according to the present invention allows rotation about the base of the drive system. When attached at position P2 or P3 and configured for driving lateral movement of the bed, the drive system provides improved maneuverability with respect to prior are drive systems.

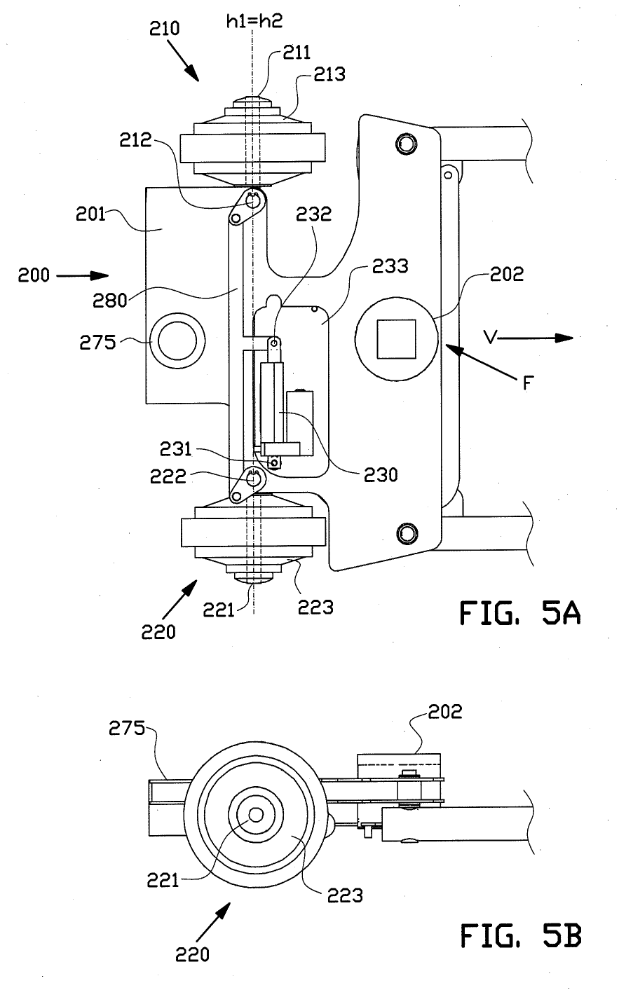

An alternative embodiment of the drive system is shown in the top view of FIG. 5A and its corresponding side view in FIG. 5B. Drive system 200 comprises a base 201, attachment means 202 for attaching a patient support device to the drive system, and first and second drive wheels 210 and 220 arranged at the sides of the base. Support column holder 275 is adapted for holding a support column and steering handle, which are not shown here to provide an unobstructed view of the base and steering mechanism. The drive wheels may be driven by drive wheel actuator means 213, 223 to rotate around their respective wheel axles 211, 222 for moving the drive system across a floor.

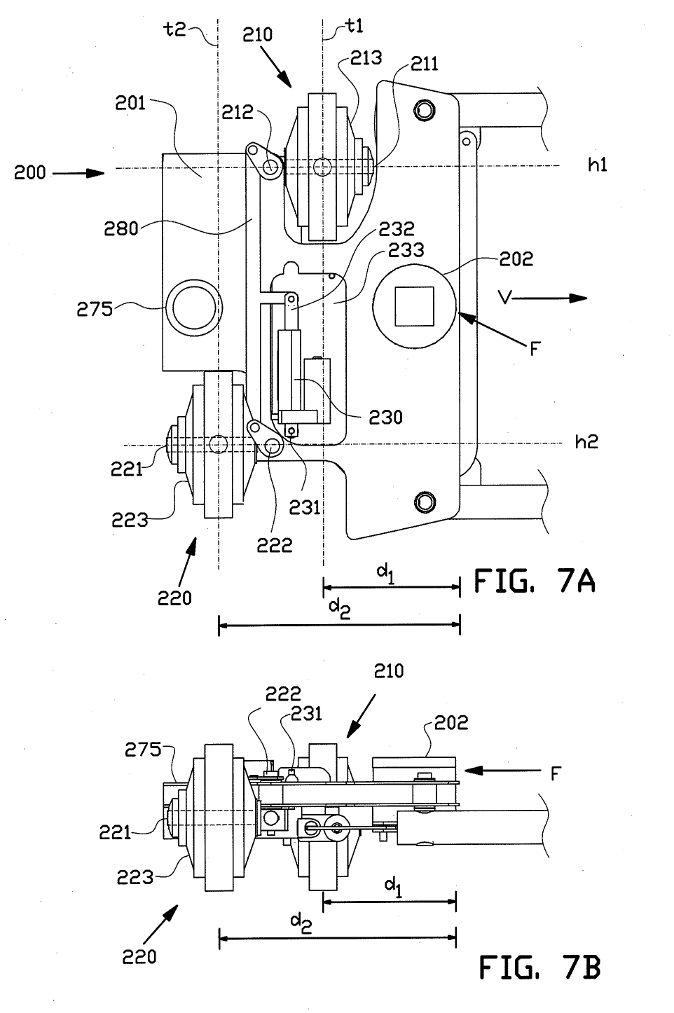

Swivel actuator means 230 may drive the drive wheels to rotate around their respective swivel axles 212, 222 to move the drive wheels 210, 220 from the first orientation or position for substantially forward movement as shown in FIG. 5A to a second orientation or position for transverse movement as shown in FIG. 7A.

In FIG. 5A, the drive wheels 210, 220 are in the first position for forward movement of the drive system 200. In this embodiment, the centre line or axis h1 of the first drive wheel 210 coincides with a centre line or axis h2 of the second drive wheel 220. To change the direction in the forward movement as shown in FIG. 5A, the first drive wheel 210 is driven with a different speed than the second drive wheel 220. Using this well known technique the drive system 200 can be maneuvered through a bend.

However in order to move the drive system 200 transverse to the forward movement direction v, the first and second drive wheels are swiveled over an angle of substantially 90 degrees to the second position as shown in FIG. 7A. In this second position the centre line or axis h1 of the first drive wheel 210 is parallel and spaced apart from a centre line or axis h2 of the second drive wheel 220. Furthermore, in this second orientation the first drive wheel 210 is positioned at a distance d1 from the front side F of the base, and second drive wheel 220 is positioned at a substantially different distance d2 from the front side F of the base. When the drive wheels 210, 220 are actuated to rotate around their wheel axles 211, 221, the drive wheels both follow a track t1, t2 substantially perpendicular to the forward movement direction v, yielding two substantially parallel tracks t1, t2 at different distances to the front side F of the base, and providing sideways movement of the drive system without substantial deviation towards the centre of mass of the load.

Because the swivel axles are arranged on the base next to the drive wheels instead of directly overhead of the drive wheels as was the case in the previous embodiment, a more compact construction is obtained in which the combined height of the base, swivel axles and drive wheels does not exceed the diameter of the drive wheels. The base is shaped such that the wheels can rotate for at least 90 degrees around their swivel axles. In the embodiment shown, swivel actuator means 230 comprises a linear actuator which is adapted to drive rotational movement of both drive wheels. One end of the swivel actuator means is attached to the base at a pivot point 231, and another end is attached to pivot point 232 on rigid bar 280 which rotation-fixedly couples both swivel axles. Cut out portion 233 in the base provides some room for the swivel actuator means and movement thereof around pivot point 231. Obviously, instead of pivot point 231 or 232 a slotted hole or similar construction may be used which allows the rigid bar 280 to be driven by swivel actuator means 230 along a circle-arc. Though not shown, rotation around the swivel axles of the first and second drive wheels may also be driven by associated first and second swivel actuator means, for instance a first and a second servo motor. In such an embodiment the first and second swivel actuator means may be coupled electrically instead of mechanically.

FIG. 5B shows a side view of the drive system. The total height of the base and swivel axles does not exceed the diameter of the drive wheels resulting in a flat and compact design.

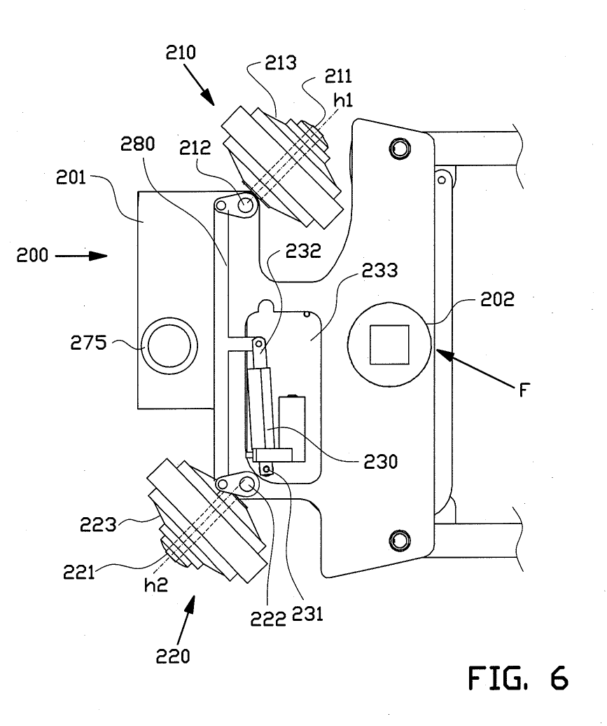

FIG. 6 shows the drive system of FIGS. 5A and 5B in which the drive wheels have been placed in an intermediate orientation.

Actuating the swivel actuator means 230 causes a circular movement of rigid bar 280 away from front side F, in turn causing the wheels to rotate around their swivel axles to the intermediate orientation. Pivot points 231 and 232 allow the actuator to rotate slightly to deal with the movement of the rigid bar perpendicular to front side F.

In FIGS. 7A and 7B the drive wheels are shown in the second orientation, in which the running surfaces of the wheels are placed substantially parallel to and at different distances d1, d2 to the front side F. In this orientation the distance of the drive wheels to the center of mass of the patient support device differs, allowing easy maneuvering of the drive system and patient support device connected thereto around sharp corners and in confined spaces, as in the previous embodiment.

It is to be understood that the above description is included to illustrate the operation of the preferred embodiments and is not meant to limit the scope of the invention. From the above discussion, many variations will be apparent to one skilled in the art that would yet be encompassed by the spirit and scope of the present invention. For example, in FIG. 2 the handle 170 with sensors 172, 173, 174 is arranged on the support column 171, but may also be provided on the lifting boom 154 or on a head end or foot end of the hospital bed 160.

In summary, the invention relates to a drive system for driving movement of a patient support device across a floor, comprising a base having a front side facing the patient support device, first and second drive wheels arranged on said base said wheels being rotatable around first and second respective wheel axles substantially parallel to the floor and rotatable around first and second respective swivel axles substantially perpendicular to the floor, wherein the first and second swivel axles are spaced apart from each other when projected onto the front side and arranged at fixed positions on the base, wherein the drive wheels are rotatable around their swivel axles between a first orientation for forward movement, and a second orientation for transverse movement, wherein in the second orientation the first and second drive wheels are positioned at substantially different distances from the front side of the base.

1. Drive system for driving movement of a patient support device across a floor, comprising:
a base (101, 201) having a front (F) side facing the patient support device,
first (110, 210) and second (120, 220) drive wheels arranged on said base (101, 201) for supporting the base on the floor, said wheels being rotatable around first (111, 211) and second (121, 221) respective wheel axles substantially parallel to the floor and rotatable around first (112, 212) and second (122, 222) respective swivel axles substantially perpendicular to the floor, wherein the first and second swivel axles are spaced apart from each other when projected onto the front side and arranged at fixed positions on the base,
drive actuator means (113, 123, 213, 223) for rotating the first (110, 210) and second (120, 220) drive wheels around their respective wheel axles,
swivel actuator means (130, 230) for rotating the first and second drive wheels around their respective swivel axles,
a power supply for supplying the drive actuator means and/or swivel actuator means with power,
control means for controlling the drive actuator means and swivel actuator means,
coupling means (131, 132, 280) for substantially rotation-fixedly coupling the first and second swivel axles,
wherein the drive wheels are rotatable around their swivel axles between a first orientation in which both wheel axles extend substantially parallel to the front side, and a second orientation in which both wheel axles extend substantially perpendicular to the front side, wherein in the second orientation the first and second drive wheels are positioned at substantially different distances from the front side of the base.

2. Drive system according to claim 1, wherein said swivel axles are arranged at substantially different distances from the front side of the base.

3. Drive system according to claim 1, wherein said swivel axles are arranged at substantially equal distances from the front side of the base.

4. Drive system according to claim 1, wherein the swivel axles are arranged above the drive wheels.

5. Drive system according to claim 1, wherein the swivel axles are arranged next to the drive wheels.

6. Drive system according to claim 5, wherein the first swivel axle is horizontally spaced apart from the first drive wheel.

7. Drive system according to claim 5, wherein in the first orientation the swivel axles are arranged in between the drive wheels.

8. Drive system according claim 1, wherein the rotation-fixed coupling of the drive wheels around their respective swivel axles comprises a mechanical coupling.

9. Drive system according to claim 8, wherein the swivel actuator means comprises a motor arranged on the base for driving the mechanical coupling to rotate the drive wheels around their swivel axles.

10. Drive system according to claim 1, wherein the drive actuator means are comprised within the respective first and second drive wheels.

11. Drive system according to claim 1, wherein the drive actuator means comprises separate actuator means for each drive wheel.

12. Drive system according to claim 1, wherein the swivel actuator means comprises a first and a second servomotor for rotating the first and second drive wheels around their respective swivel axles.

13. Drive system according to claim 12, wherein the control means are adapted for controlling the swivel actuator means to rotate the first and second drive wheels around their respective swivel axles at substantially equal speeds and over substantially equal angles of rotation.

14. Drive system according to claim 1, wherein the drive system is an integral part of the patient support device.

15. Drive system according to claim 1, further comprising attachment means for releasably attaching the drive system to the patient support device.

16. Drive system according to claim 15, wherein the attachment means comprise an adapter plate arranged on the base, for connecting with different patient support devices.

17. Drive system according to claim 1, wherein the patient support device is a patient lifting device or a hospital bed.

18. Drive system according to claim 1, further comprising a steering handle adapted for generating a signal representing one or force components manually applied to the handle, wherein the control means are adapted for controlling the drive actuator means and/or swivel actuator means based on said signal.

19. Drive system according to claim 18, wherein the steering handle comprises three sensors, preferably force sensors, for sensing rotational and/or translational movement of the steering handle with respect to the base.

20. Drive system according to claim 18, wherein the steering handle is arranged on either the base or on the patient support device.

21. Drive system according to claim 20, wherein the steering handle is a push handle for manually applying force to said push handle to steer movement of the base or on the patient support device.

22. Drive system for driving movement of a patient support device across a floor, comprising:
a base (101, 201) having a front (F) side facing a forward movement direction (v),
a first drive wheel (110, 210) arranged on said base (101, 201) for supporting the base on the floor, wherein said first drive wheel (110, 210) is drivable to rotate around a first wheel axis (h1) substantially parallel to the floor along a first track (t1), and wherein the first drive wheel (110, 210) is rotatable with respect to said base (101, 201) around a first swivel axle (112, 212) substantially perpendicular to the floor,
a second drive wheel (120, 220) arranged spaced apart from said first drive wheel (110, 210) on said base (101, 201) for supporting the base on the floor, wherein said second drive wheel (120, 220) is drivable to rotate around a second wheel axis (h2) substantially parallel to the floor along a second track (t2), and wherein the second drive wheel (120, 220) is rotatable with respect to said base (101, 201) around a second swivel axle (122, 222) substantially perpendicular to the floor, wherein the first swivel axle (112, 212) is spaced apart from the second swivel axle (122, 222), and
wherein the first (110, 210) and second (120, 220) drive wheels are rotatable around their swivel axles between a first orientation in which both wheel axes (h1, h2) extend substantially perpendicular to the forward movement direction (v), and a second orientation in which both wheel axes (h1, h2) extend substantially parallel to the forward movement direction (v), wherein in the second orientation the first track (t1) is spaced apart from the second track (t2).

23. Drive system according to claim 22, wherein in the second orientation the first track (t1) is substantially parallel to the second track (t2).

24. Drive system for driving movement of a patient support device across a floor, comprising:
a base (101, 201) having a front (F) side facing the patient support device,
first (110, 210) and second (120, 220) drive wheels arranged on said base (101, 201) for supporting the base on the floor, said wheels being rotatable around first (111, 211) and second (121, 221) respective wheel axles substantially parallel to the floor and rotatable around first (112, 212) and second (122, 222) respective swivel axles substantially perpendicular to the floor, wherein the first and second swivel axles are spaced apart from each other when projected onto the front side and arranged at fixed positions on the base,
drive actuator means (113, 123, 213, 223) for rotating the first (110, 210) and second (120, 220) drive wheels around their respective wheel axles,
swivel actuator means (130, 230) for rotating the first and second drive wheels around their respective swivel axles,
a power supply for supplying the drive actuator means and/or swivel actuator means with power,
control means for controlling the drive actuator means and swivel actuator means,
coupling means (131, 132, 280) for substantially rotation-fixedly coupling the first and second swivel axles,
wherein the patient support device has a centre of mass (L) located substantially in a vertical plane (C) with respect to the base, the drive wheels being rotatable around their swivel axles between a first orientation in which both wheel axles extend substantially parallel to the vertical plane, and a second orientation in which both wheel axles extend substantially perpendicular to the vertical plane, and wherein in the second orientation the first and second drive wheels are arranged at substantially different distances from the centre of mass (R1, R2).

25. Patient support device comprising a drive system according to claim 1.

26. Patient support device comprising a drive system according to claim 22.

27. Patient support device comprising a drive system according to claim 24.
